(19) United States
(12) Patent Application Publication
(10) Pub. No.: US 2014/0130764 A1
(43) Pub. Date: May 15, 2014

(54) CHARGE AIR DUCT FOR AN INTERNAL COMBUSTION ENGINE

(71) Applicants: MANN + HUMMEL GMBH, Ludwigsburg (DE); BEHR GMBH & CO. KG, Stuttgart (DE)

(72) Inventors: Christian SAUMWEBER, Stuttgart (DE); Ulrich DEHNEN, Kornwestheim (DE); Karl-Ernst HUMMEL, Bietigheim-Bissingen (DE)

(73) Assignees: MANN + HUMMEL GMBH, Ludwigsburg (DE); BEHR GMBH & CO. KG, Stuttgart (DE)

(21) Appl. No.: 14/072,012

(22) Filed: Nov. 5, 2013

Related U.S. Application Data
(63) Continuation of application No. PCT/EP2012/058406, filed on May 7, 2012.

(30) Foreign Application Priority Data
May 5, 2011 (DE) DE102011100629.3

(51) Int. Cl. F02M 35/10

(52) U.S. Cl. CPC F02M 35/10
USPC 123/184.21

(57) ABSTRACT

A charge air duct for an internal combustion engine is provided that includes a housing having at least one inlet and at least one outlet for combustion air, and a heat exchanger, which is arranged in the housing and through which a fluid can flow, for cooling and/or heating the charge air. The housing is reinforced against pressure of the combustion air via a tie rod, wherein the tie rod is structurally integrated with the heat exchanger.

This nonprovisional application is a continuation of International Application No. PCT/EP2012/058406, which was filed on May 7, 2012, and which claims priority to German Patent Application No. DE 10 2011 100 629.3, which was filed in Germany on May 5, 2011, and which are both herein incorporated by reference.

### BACKGROUND OF THE INVENTION

1. Field of the Invention

The invention relates to a charge air duct for an internal combustion engine.

2. Description of the Background Art

WO 2010/118848 A1, which corresponds to US 20120097136 and US20120090579, which are herein incorporated by reference and which describes a charge air duct in which a heat exchanger is inserted into a charge air-conducting intake manifold housing of an internal combustion engine. A tie rod, with the aid of which an improved stability of the housing against the pressure of the charge air may be achieved, is also provided in the intake manifold housing.

### SUMMARY OF THE INVENTION

It is an object of the present invention to provide a charge air duct for an internal combustion engine which has a stable and compact design.

According to an embodiment of the invention, and due to the integration of the tie rod and heat exchanger, a small amount of installation space is needed, on the one hand, and the housing is advantageously supported in an area that is subjected to high load by the pressure of the combustion air, on the other hand.

An integrated design in the sense of the invention includes at least two possible variations. In one variation, the tie rod is designed as a component which is separate from the heat exchanger but is disposed adjacent to the heat exchanger, for the purpose of absorbing force. In another variant, the heat exchanger itself is part of the tie rod and therefore absorbs at least a portion of the supporting forces acting against the pressure.

Combustion air in the sense of the invention is understood to be, in particular, compressed charge air which may also include admixtures of recycled exhaust gas, etc., depending on the design. The charge air duct is preferably designed as an intake manifold which directly adjoins the cylinder head of an internal combustion engine.

In an embodiment, it is provided that the heat exchanger is designed as a slide-in module having a cover flange, the heat exchanger being inserted into an opening in the housing and the opening being closed by the cover flange. A combination of the tie rod according to the invention with this design is particularly advantageous, since the opening weakens the rigidity of the housing, and a tie rod is thus particularly effective in this area.

In an embodiment of the invention, the tie rod includes a tension rod which preferably engages with at least one wall of the housing. In the preferred but not necessary event that the tension rod is not fixedly connected to the heat exchanger, this corresponds to the aforementioned variant of a tie rod which is separate from the heat exchanger for the purpose of absorbing force. In particular, multiple tension rods may be provided along the length of the heat exchanger to capture compressive forces distributed over a larger area.

In an embodiment, the heat exchanger is designed as a tube bundle heat exchanger having multiple rows of tubes through which fluid flows. The tension rod engages with the heat exchanger between two consecutive rows of tubes, which is structurally easy to implement.

In an alternative embodiment, the heat exchanger may be designed as a stacked plate heat exchanger. Preferably but not necessarily, the tension rod may pass through the heat exchanger in an area of overlapping openings in the stacked plates. Such openings may be, for example, formed as perforated cups having turned-up edges, the edges of the cups of consecutive plates being soldered to each other fluid-tight.

In another embodiment, the tie rod includes an anchor member connected to the housing and at least one tube sheet of the heat exchanger. Particularly preferably but not necessarily, the anchor member is simultaneously connected to two tube sheets of the heat exchanger situated opposite each other. In a design of this type, the heat exchanger itself acts as a tie rod, into which the compressive forces acting upon the housing are introduced. Due to the connection of the anchor member to the tube sheet, the forces may be at least partially introduced into the tube sheet in the form of a particularly stable part of the heat exchanger. As a result, the danger of damage to the heat exchanger caused by the function as a tie rod is reduced.

The tube sheet can be part of a heat exchanger grid of flat tubes which are inserted into the tube sheet. The tube sheet may be, for example, part of a water box. For the sake of easy manufacturing, the tube sheet is designed as a simple sheet metal molding having passages for the flat tubes.

In an embodiment, the anchor member is designed as a profile bar extending along the length of the heat exchanger. For example, the profile can be provided with a T shape, an L shape or be shaped in another manner to enable it to engage with a corresponding receptacle on the housing in a form-locked manner. In particular, the profile bar may be differently shaped and/or machined on its ends to facilitate connection to the tube sheet.

In an embodiment, the profile bar can be soldered at least in sections to a side surface of the heat exchanger. In addition to a better distribution of force absorption, this provides an improved barrier against leakage flows of the combustion air on the sides of the heat exchanger. The side surface is understood to be any side termination of the heat exchanger, for example a side part or cover sheet of a heat exchanger grid or a terminal rib or a terminal heat exchanger tube of the heat exchanger grid.

In an embodiment, the anchor member engages with a formation of the tube sheet in a form-locked manner, which ensures a simple and effective transmission of force. The formation may be an opening or, for example, a cup-like indentation.

Depending on the requirements, the anchor member may also be soldered to the tube sheet. In particular, a fluid-tight soldering may be provided in the area of the formation, provided that the latter is designed as an opening.

Depending on the requirements, a water box of the heat exchanger may be provided on the side of the tube sheet opposite the anchor member. The water box may, but does not have to, cover the formation. In the event of a coverage, a fluid-tight formation is necessary, which may be provided, for example, with the aid of a cup-like indentation or with the aid of fluid-tight soldering of an opening to the inserted anchor member. If the anchor member is connected to two tube sheets situated opposite each other, the particular connection to the two tube sheets may be established in different ways.

In another embodiment of the invention, the tie rod is designed as at least one formation of the housing adjoining the heat exchanger. The formation may be provided next to the heat exchanger, or it may pass through the heat exchanger. Preferably but not necessarily, the tie rod may simultaneously act as a guide for the charge air. A formation of this type may be provided, for example, to form a single piece with the housing and be made of the same material. For example, it may be webs projecting from the housing wall which are connected to corresponding structures of an opposite wall during the course of assembly, for example with the aid of gluing, screwing and/or welding. Preferably but not necessarily, the at least one formation may support or hold the heat exchanger in at least one direction. In a variant of this type, the tie rod not only adjoins the heat exchanger, it is also in direct contact therewith. Overall, this approach may provide a cost-effective variant of a tie rod, possibly one which integrates multiple functions.

In another embodiment, the tie rod can be disposed on one side of the heat exchanger. This preferably establishes a form-locked connection between the tie rod and the housing. In a generally advantageous detailed design, the tie rod is designed as a flat component, in particular a sheet metal molded part which has openings through which the charge air flows. A component of this type is easy and economical to manufacture. The laterally disposed tie rod may be designed as a separate component, depending on the detailed design, which is used for assembly with the housing after the heat exchanger is soldered. Alternatively, the laterally disposed tie rod may also be designed as component which forms a single piece with the heat exchanger or is soldered thereto.

In an embodiment of the invention, the tie rod comprises a sheathing provided on the housing. Depending on the design, a sheathing of this type makes it possible to reinforce the housing in the area of the force introduction, and/or the force is distributed by the sheathing to a larger area of the housing. The sheathing may be, in particular, a longitudinal body, such as a sheet metal part which is bent into a U-shape or an L shape or an organic sheet.

In an embodiment, the tie rod may comprise an organic sheet. Both the entire tie rod or only one part, for example a sheathing, may be designed as an organic sheet. The organic sheet is preferably attached to a plastic material in a form-locked and/or integral manner, so that an optimum distribution of the force absorbed by the tie rod occurs.

An organic sheet can be understood to be a fiber-reinforced plastic, in particular a continuous fiber-reinforced, thermoplastic fiber-reinforced plastic. Further advantages and features of the invention are derived from the exemplary embodiments described below as well as from the dependent claims.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a spatial view of a heat exchanger according to an embodiment of the invention;

FIG. 2 shows a sectional view of the heat exchanger from FIG. 1 in a charge air duct;

FIG. 3 shows a top view of a heat exchanger according to an embodiment of the invention;

FIG. 4 shows a sectional view of the heat exchanger from FIG. 3 in a charge air duct;

FIG. 5 shows an embodiment of the invention as a spatial representation of one half of the housing, including formations designed as tie rods;

FIG. 6 shows an embodiment of the invention which includes a side tie rod;

FIG. 7 shows a modification of the embodiment from FIG. 6;

FIG. 8 shows another modification of the embodiment from FIG. 6;

FIG. 9 shows another embodiment of the invention which includes a sheet-type tie rod; and

FIG. 10a through 10c show variants of tie rods according to the present invention, including sheathings.

### DETAILED DESCRIPTION

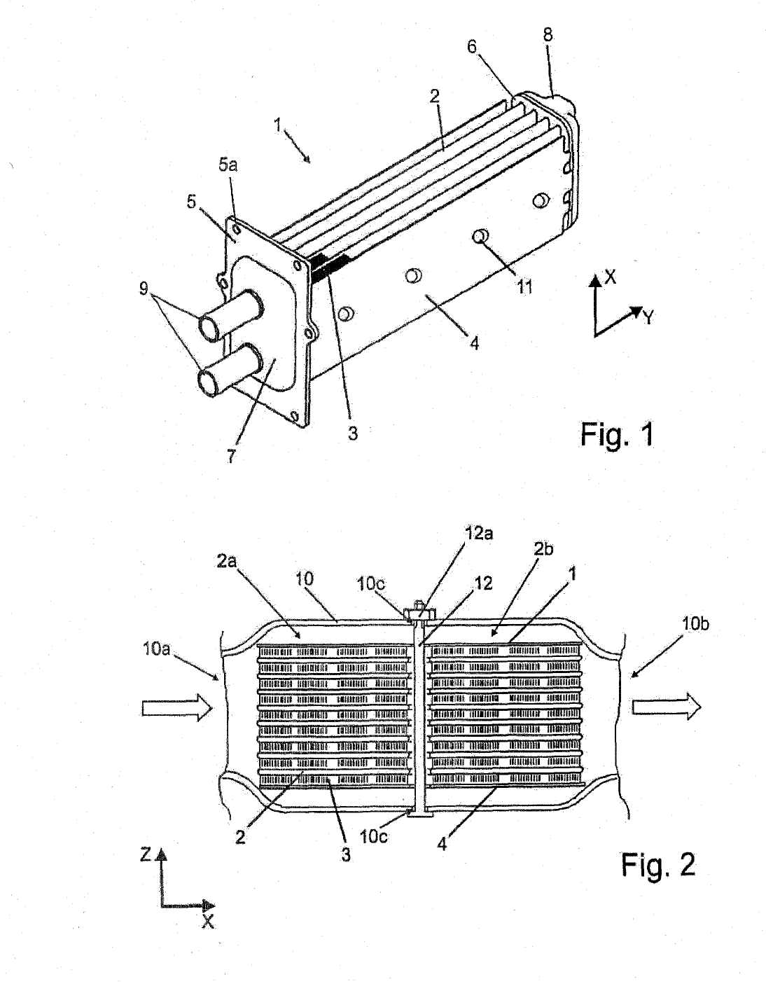

A heat exchanger 1 illustrated in FIG. 1 and FIG. 2 is designed as a tube bundle heat exchanger. A plurality of flat tubes 2 is stacked in a first row 2a and a second row 2b to form a heat exchanger grid, ribs 3 being disposed between consecutive flat tubes 2. The stacks or rows 2a, 2b of flat tubes are terminated on the ends by continuous side parts 4 in the form of metal plates.

The flat tubes 2 are each inserted by their open tube ends into passages in tube sheets 5, 6. Tube sheets 5, 6 are connected to water boxes 7, 8, in which an, in particular, liquid cooling fluid is distributed to the exchanger tubes.

In the exemplary embodiment, the heat exchanger is designed as a U flow heat exchanger. One of tube sheets 5 simultaneously forms a cover flange and has a divided water box 7 for supplying and discharging the fluid by means of connections 9. Opposite tube sheet 6 has an undivided water box 8 for deflecting the fluid by 180 degrees.

At least flat tubes 2, ribs 3, side parts 4 and tube sheets 5, 6 of heat exchanger 1, in particular also water boxes 7, 8, are manufactured on the basis of aluminum and soldered to each other in a soldering furnace.

Heat exchanger 1 is designed as a slide-in module in a charge air duct having a housing 10 which has an inlet 10a and an outlet 10b for the charge air. Charge air duct 10 may be made, in particular, of plastic or aluminum and has an opening into which heat exchanger 1 may be inserted. Tube sheet 5, which is designed as a cover flange, closes the opening. In the present case, bore holes 5a are provided in tube sheet 5 for attaching the heat exchanger to the housing.

Heat exchanger 1 also has multiple continuous openings 11 in side parts 4, which overlap with a gap between adjacent tube rows 2a, 2b. After being inserted into housing 10, tie rods 12 in the form of tension rods, screw bolts in the present case, are inserted into housing 10 through bore holes 10c which fully penetrate the heat exchanger through openings 4 and the gap (see sectional view in FIG. 2).

Tie rod 12 is secured to housing 10 from the outside using a screw nut 12a. Since tie rod 12 fully penetrates heat exchanger 1, it is designed to be integrated therewith. Nevertheless, it is not fixedly connected to heat exchanger 1, so that a thermal expansion of heat exchanger 1 and a thermal expansion of tie rod 12 take place independently of each other.

Heat exchanger 1 is used as a charge air cooler during normal operation, it being possible to also heat the air in special operating situations. The charge air, which is under overpressure and heated, flows through heat exchanger 1 in the housing in the X direction, the heat being transferred to the fluid flowing in the tubes via the flat tubes around which the flow passes. The pressure of the combustion air places a mechanical load on housing 10. A support of the housing counteracts the overpressure in the Z direction due to tension rods 12.

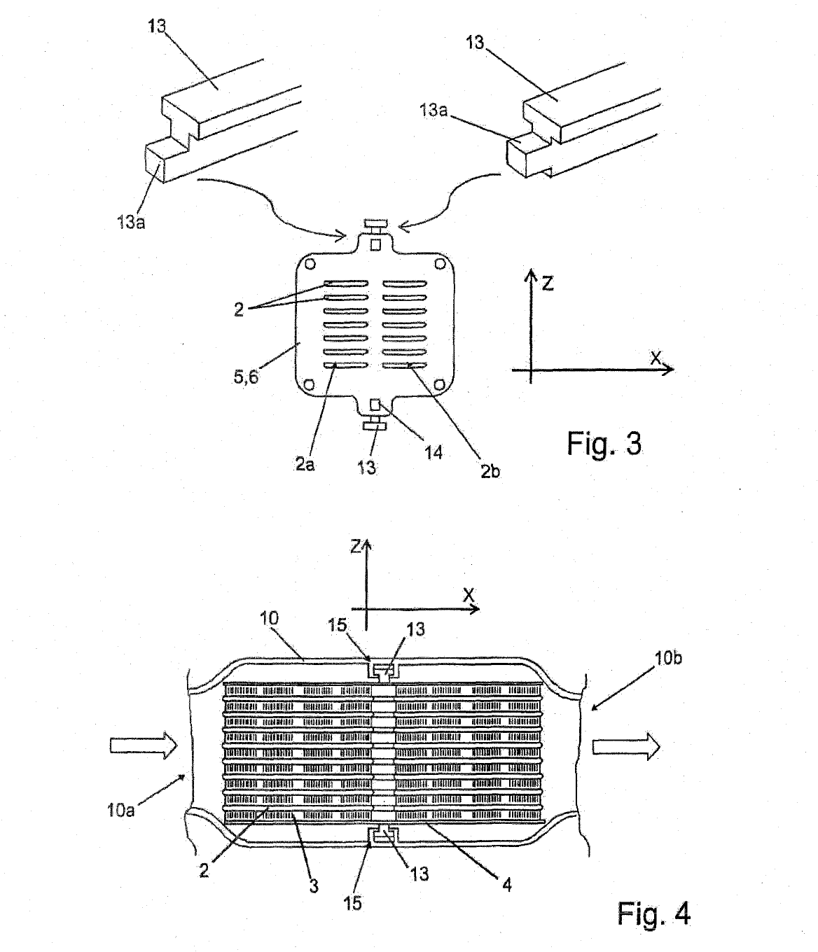

In a second exemplary embodiment according to FIG. 3 and FIG. 4, heat exchanger 1 is structurally designed as a slide-in tube bundle heat exchanger comprising flat tubes, just like in the first example. In contrast to the first example, the heat exchanger itself is part of a tie rod for supporting housing 10 against the pressure of the combustion air.

For this purpose, an upper and a lower anchor member 13 are attached to heat exchanger 1. Anchor members 13 are designed as profile bars which are each accommodated by their ends in formations 14 in opposite tube sheets 5, 6 in a form-locked or integral manner.

The profile bars may be manufactured in any manner, for example as an extruded profile and/or in another manner, e.g. by cutting, stamping or casting.

In the present case, the profile bars have a T-shaped cross section, the cross bars of the T cross section being insertable in a form-locked manner into a corresponding receptacle 15 of the housing. Ends 13a of the profile bars may be shaped and/or remachined for adaptation to formations 14 of tube sheets 5, 6. Two alternative methods for machining the profile bars are illustrated by way of example in FIG. 3.

In this manner, a compressive force of the combustion air acting upon the housing may be introduced at least into tube sheets 5, 6 of heat exchanger, 1 via receptacles 15 in the Z direction of profile bars 13 and via profile bars 13.

Profile bars 13 advantageously adjoin side parts 4 or side surfaces of heat exchanger 1, whereby they simultaneously provide an effective barrier against unwanted leakage flows of the combustion air on the outsides of the heat exchanger. For the purpose of further mechanical reinforcement and to improve the seal against leakage flows, anchor members 13 may also be soldered over a wide area to side parts 4 of the heat exchanger.

Formations 14 in tube sheets 5, 6 may be designed, in particular, as openings or as cup-like indentations. Depending on the requirements, they may overlap with a water box 7, 8 of tube sheet 5, 6 or be located outside the water box. In the illustrated example according to FIG. 3, formations 14 are located for this purpose in the area of latching tabs of the tube sheet which project over the edge.

In the example according to FIG. 3, profile bars 13 in the top view partially project over the edge of tube sheet 5, 6. To ensure a simple function as a cover flange, it may be provided, for example, that the profile bar projects only when the tube sheet is inserted into the opening in the housing and is located within an overlapping area with tube sheet 5 (not illustrated), which acts as a cover flange.

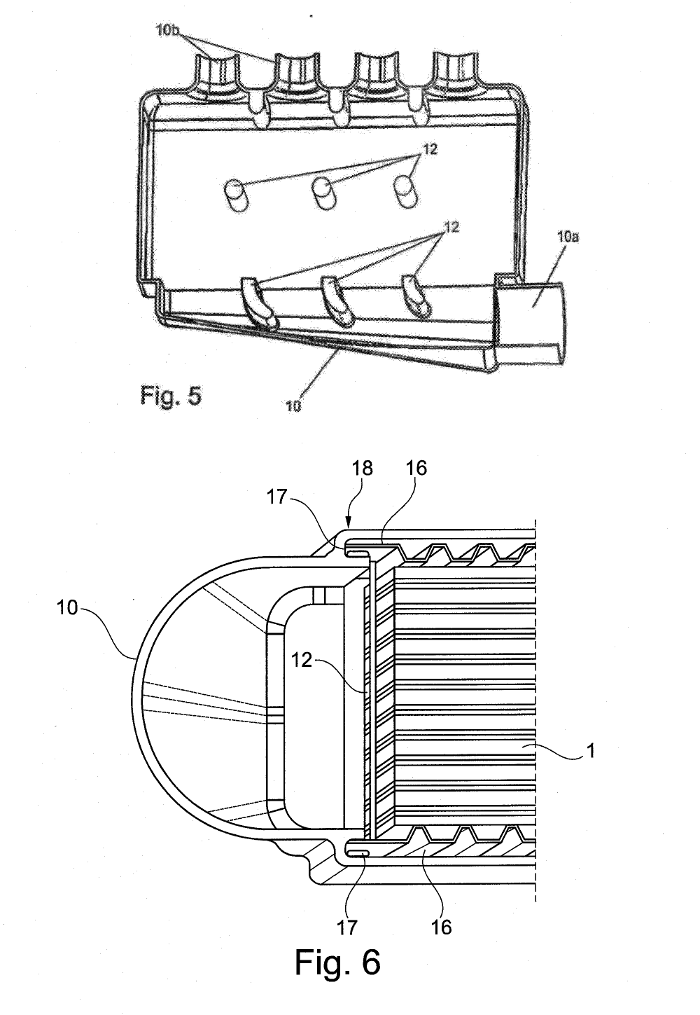

In the example illustrated in FIG. 5, multiple tie rods 12 are provided on housing 10 in the form of projections which form a single piece and are made of the same material. Housing 10, together with projections 12, may be, for example, an injection-molded plastic part. The heat exchanger (not illustrated) is inserted into the housing between tie rods 12 in such a way that its side walls adjoin tie rods 12 and are held in position thereby. Some of tie rods 12 are designed to be bent in profile on the side of inlet 10a, for the purpose of acting as air conducting elements and deflecting the air by approximately 90 degrees into the heat exchanger. On the output side, some of tie rods 12 have a straight cross section, whereby they also perform an air conducting function, since they separate multiple outlets 10b, which are assigned to the individual cylinders of an internal combustion engine. Other tie rods 12 are designed as central projections, which, like in the example according to FIG. 2, pass through the heat exchanger, for example in the area between two exchanger rows.

The projections or tie rods 12 are fixedly connected in the assembled state to corresponding mating pieces (not illustrated) of another housing part. The high tensile connection may be established, for example by gluing, welding and/or screwing.

In the example according to FIG. 6, tie rod 12 comprises a tension rod made of metal which is disposed laterally next to heat exchanger 1 and which connects an upper and a lower side part 16 of heat exchanger 1 to each other. The heat exchanger is designed as a tube bundle heat exchanger, and side parts 16 in the present case are fixedly soldered to heat exchanger 1 in the form of profiled sheet metal formed parts. Side parts 16 have projecting edges 16d which engage with sheathings 17. Sheathings 17 are U-shaped, bent strips made of an organic sheet, each of which is inserted in an integral and form-locked manner into a pocket 18 of housing 10, which is cast from plastic. The tie rod is thus formed as a whole by side parts 16, sheathings 17, pockets 18 and tension rods 12.

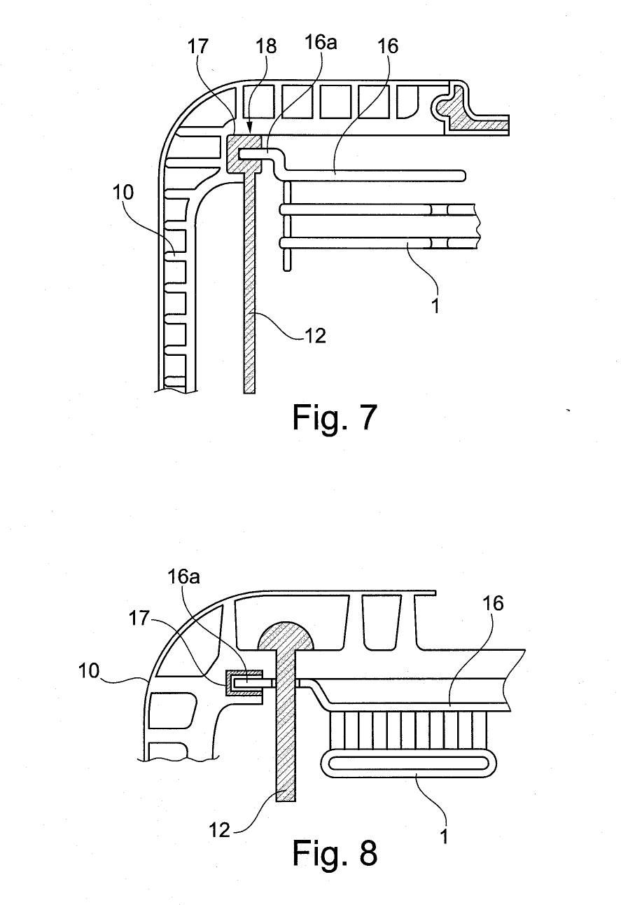

In the embodiment according to FIG. 7, an arrangement similar to FIG. 8 is provided, in which, however, tension rod 12 forms an integrated unit with sheathing 17. This unit may be made, for example, of metal or, for example, from an organic sheet. Depending on the requirements, tie rod 12 may be soldered to heat exchanger 1 or be installed as a separate part. In particular, the heat exchanger may be inserted into sheathing 17, as in the case of the example according to FIG. 6.

Another modification of the principle from FIG. 6 is shown in FIG. 7. In this case, tie rod 12 is riveted and/or screwed into sheathing 17 after heat exchanger 1 is inserted. Tie rod 12 may be disposed on the side or pass through heat exchanger 1, as in the example according to FIG. 2.

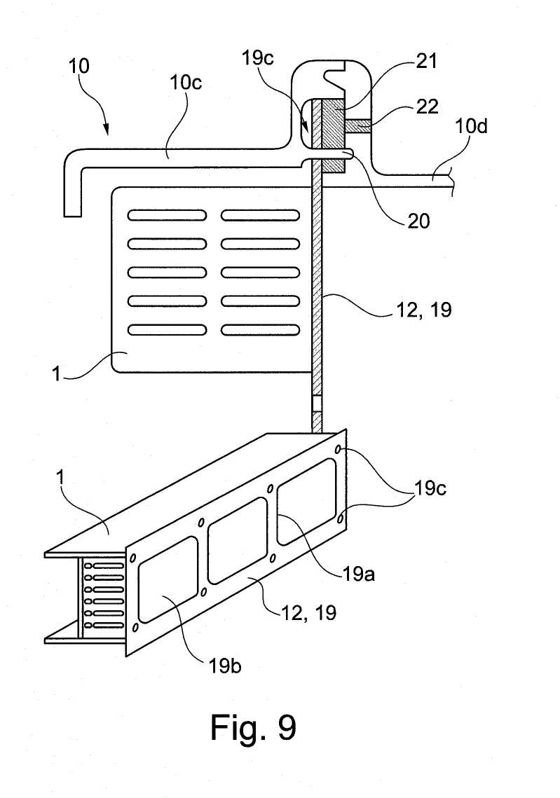

FIG. 9 shows an exemplary embodiment in which tie rod 12 is designed as a flat component in the manner of a sheet metal molded part 19. Unlike, for example the side parts in FIG. 6, sheet metal molded parts 19 are disposed on the air inlet-side and/or air outlet-side front sides of heat exchanger 1 and, in particular, soldered together with the heat exchanger. Sheet metal parts 19 have openings 19b between webs 19a, through which the charge air is able to pass. On the edge, sheet metal part 19 projects over heat exchanger 1 and has structures 20, in the form of bore holes in the present case, with the aid of which it is connectable under tension to the housing.

The sectional view in FIG. 9 shows that, for example, projecting tabs 20 of one housing half 10c pass through bore holes 19c and thereby connect sheet metal parts 19 to housing 10 in a form-locked manner. Sheet metal part 19 is advantageously accommodated on the housing in area 22 of the connection between two housing halves 10c, 10d. Housing halves 10c, 10d form a cavity and/or a labyrinth between themselves, which is filled with a sealant 21 through an injection opening 22. Alternatively, a preformed sealing gasket may also be inserted.

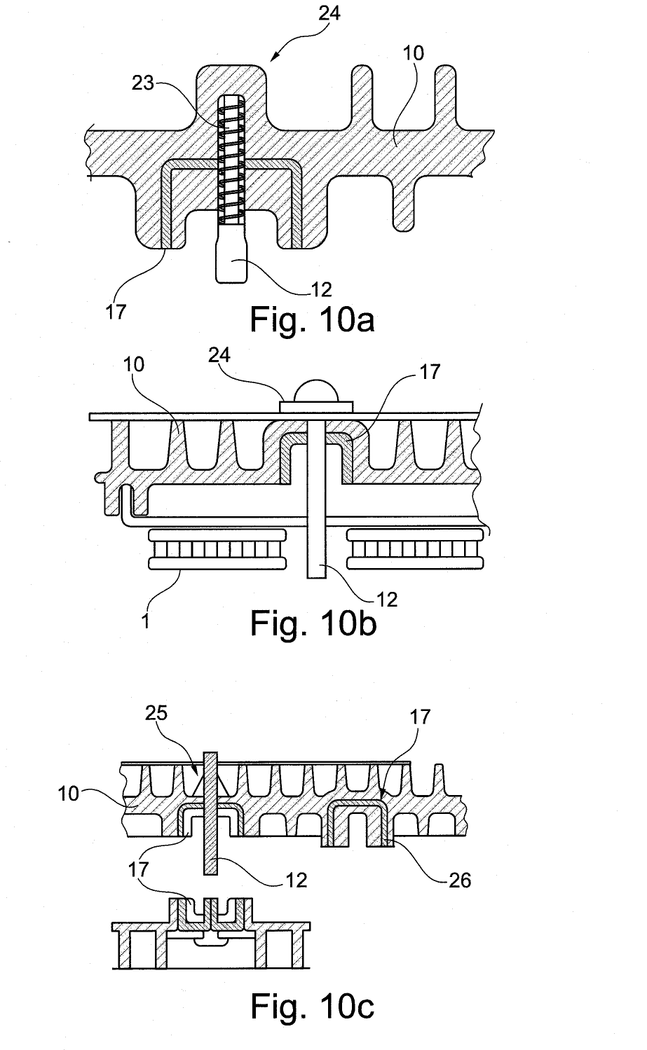

The drawings in FIG. 10a through FIG. 10c show supplementary modifications for combining an integrated tie rod 12 with sheathings 17. In the case of FIG. 10a, tie rod 12 is screwed into a receptacle 24 of housing 10 with the aid of a terminal thread 23, sheathing 17 being integrated, in particular integrally, in the area of the receptacle. The sheathing ensures a better distribution of force and a better hold of thread 23.

In the case of the example from FIG. 10b, the tension rod is provided as a riveted bolt, at least on one side, which is inserted into housing 10 from the outside, together with a sealing washer 24. A sheathing 17 in the form of an organic sheet is disposed for reinforcement in the slide-in area and is also penetrated by the riveted bolt.

In the case of the example according to FIG. 10c, the tie rod or riveted bolt 12 also has a latching hook 25 on the end, with the aid of which it penetrates in a latching manner with an opposite side, which is also reinforced by a sheathing 17. Another sheathing 17 is adjacently provided for forming a receptacle for heat exchanger 1 and a sealing gasket 26.

It is understood that the individual features of the various exemplary embodiments may be reasonably combined with each other, depending on the requirements.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A charge air duct for an internal combustion engine, the charge air duct comprising:
a housing that has at least one inlet and at least one outlet for combustion air; and
a heat exchanger that is arranged in the housing, and through which a fluid flows, for cooling and/or heating the charge air, the housing being reinforced against a pressure of compression air by a tie rod,
wherein the tie rod is structurally integrated with the heat exchanger.

2. The charge air duct according to claim 1, wherein the heat exchanger is configured as a slide-in module having a cover flange, and wherein the heat exchanger is inserted into an opening in the housing and the opening being closed by the cover flange.

3. The charge air duct according to claim 1, wherein the tie rod comprises a tension rod that passes through the heat exchanger and which passes through at least one wall of the housing.

4. The charge air duct according to claim 3, wherein the heat exchanger is configured as a tube bundle heat exchanger having multiple rows of tubes through which fluid flows, and wherein the tie rod passes through the heat exchanger between two consecutive tube rows.

5. The charge air duct according to claim 3, wherein the heat exchanger is configured as a stacked plate heat exchanger, and wherein the tie rod passes through the heat exchanger in an area of overlapping openings in the stacked plates.

6. The charge air duct according to claim 1, wherein the tie rod comprises an anchor member that is connected to the housing and to at least one tube sheet or two opposite tube sheets of the heat exchanger.

7. The charge air duct according to claim 6, wherein the anchor member is configured as a profile bar that extends over a length of the heat exchanger.

8. The charge air duct according to claim 7, wherein the profile bar is soldered to a side surface of the heat exchanger, at least in sections.

9. The charge air duct according to claim 6, wherein the anchor member engages with a formation of the tube sheet in a form-locked manner.

10. The charge air duct according to claim 1, wherein the tie rod is configured as at least one formation of the housing which adjoins the heat exchanger, and wherein the tie rod is a guide for the charge air.

11. The charge air duct according to claim 1, wherein the tie rod is arranged on one side of the heat exchanger, and wherein a form-locked connection is established between the tie rod and the housing.

12. The charge air duct according to claim 11, wherein the tie rod is configured as a flat component or a sheet metal molded part which has openings through which the charge air flows.

13. The charge air duct according to claim 1, wherein the tie rod comprises a sheathing provided on the housing.

14. The charge air duct according to claim 1, wherein the tie rod comprises an organic sheet that is attached to a plastic material of the housing in a form-locked and/or integral manner.
